(19) United States
(12) Patent Application Publication
(10) Pub. No.: US 2006/0264198 A1
(43) Pub. Date: Nov. 23, 2006

(54) Method for wide band data transfer

(76) Inventor: Anoop Nahar, Ratingen (DE)

Correspondence Address: HARNESS, DICKEY & PIERCE, P.L.C., P.O. BOX 828, BLOOMFIELD HILLS, MI, 48303, US

(21) Appl. No.: 11/401,446

(22) Filed: Apr. 10, 2006

(30) Foreign Application Priority Data
Apr. 19, 2005 (EP) 05008465.6

(51) Int. Cl. H04Q 7/20; G06F 15/16

(52) U.S. Cl. 455/403; 709/218

(57) ABSTRACT

A wide band channel is used to transfer high data content communications such as images, films, music and the like whereas low band width control functions such as authentication, access control, and selection are transmitted by way of a mobile radiotelephone.

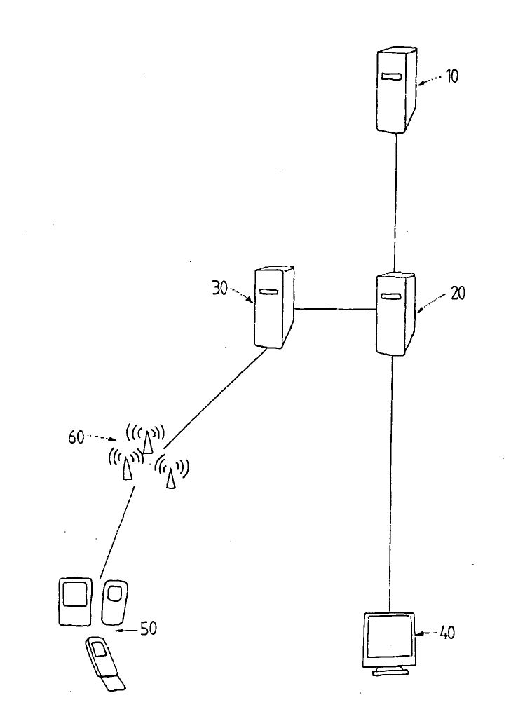

The present invention relates to a method for data transfer via at least one wide band channei.

Such a wide band data transfer can be for example realized by means of a private internet access or a home computer. An important advantage of the use of a home computer is that this one can be arbitrarily configurated by the user thereof and be provided with the necessary software, whereby a system adjustment is achieved that is specifically adapted to the user. Accordingly, most different applications can be implemented. Another advantage of home computers is that the final user can be identified and authenticated for example by means of the private internet access. In this way, the final user can for example also call pages or applications with costs in the internet, which can then be invoiced via the private telephone bill. However, the lacking mobility of home computers is an important drawback.

In this connection, diverse mobile terminals present a solution. Laptops are for example as user friendly as home computers since they comprise big displays, keyboards, normally sufficient memory capacity and the necessary band width. However, laptops are relatively great and heavy, which is the reason for final users to often decide against taking them always along

With regard to terminal size and terminal weight, so called handhelds are advantageous which are very small, light and handy, such that the final user can easily take them along. However, handhelds have correspondingly small displays, unpractical keyboards, usually a relatively small memory capacity and the like. Furthermore, being mobile they only enable a data transfer via a mobile radiotelephone channel of a mobile radiotelephone net, whereby the data transfer of especially large data amounts requires a lot of time.

In order to assure both the desired mobility and the desired user friendliness, more and more publicly accessible wide band terminals with internet access are provided, which present a web browser which can be identified and be addressed via an IP address. Large data amounts can be transferred via such wide band terminals in short periods of time. However, a big disadvantage of such publicly accessible wide band terminals is that these ones can only be preset by the final user in a limited way by means of suitable software or configuration. Therefore, many and particularly special data formats can frequently not be opened by public wide band terminals. Another drawback is that a final user who uses such a wide band terminal cannot be identified or authenticated, such that for example pages or applications with costs cannot be called. It is therefore an object of the present invention to provide a method for data transfer via at least one wide band channel, which assures the desired mobility and user friendliness and also enables an identification and authentication of the final user.

According to the present invention, this aim is achieved by a method for data transfer via at least one wide band channel, in which control statements for the wide band data transfer can be carried out via at least one channel of a mobile radiotelephone net.

Thanks to the parallel use of a wide band channel and a mobile radiotelephone channel the advantages of the respective methods can be combined. High data amounts can be handled in short times via the wide band channel. Control statements, for which only small data amounts have to be sent, are however sent via a mobile radiotelephone channel. The use of the mobile radiotelephone channel allows the identification and authentication of the final user. Accordingly, it is principally possible to charge the use of applications with costs to the final user's account.

A basic idea of the method according to the invention is to build up a connection for the data transfer in form of a session via both the wide band channel and the mobile radiotelephone channel, wherein control functions related to the session, such as for example authentication, access control, selection of data to be transferred or the like are strictly separated from the associated contents related to the application, such as for example images, films, music, e-mail, appendices, etc. While the control functions with their relatively small requirements with regard to band width, display dimensions and keyboards are exclusively realised via the mobile radiotelephone channel, the transfer of the data as such with its high requirements of speed, displays and the like is realized via the wide band access channels.

In this way, the advantages of personal mobile radiotelephone data services and anonymous wide band data accesses are combined, whereby the final user is for example enabled to have an optimum access to his personal data. Existing internet uses can obtain the same security and personalisation as mobile uses. The known advantages, such as identity, authentication and control of mobile uses are also made accessible in the wide band area.

At least one wide band terminal is preferably used for the wide band data transfer. A mobile radiotelephone terminal such as for example a mobile phone preferably serves for carrying out the control statements. In this manner, a safe display and use of confidential and personal or protected user programs or contents via anonymous wide band channels can be realized by means of session control and contents control by a mobile terminal, wherein the mobile phone quasi serves as remote control for wide band accesses.

In the method according to the invention, for identifying a final user a basic registration and/or an identification of the final user via the at least one mobile radiotelephone channel, which is used for the transfer of the control statements, is realized each time before starting the real wide band data transfer. The simplest possibility is to make use of the already carried out authentication of the mobile phone in the net of the mobile radiotelephone operator. In addition to the IP address, which is temporally but unequivocally allocated to the mobile phone and thus to the final user, the mobile radiotelephone operator can safely determine the identity in form of an allocation to the MSISDN of the final user. Furthermore, the access to the SIM card from the application software is possible by means of API (Application Programming Interface) and can be used for the identification. Finally, within the scope of a special provisioning process, safe keys for a Public Key Infrastructure method, briefly PKI method can be saved on the mobile phone and be used for the authentication of the final user. A simple WAP (Wireless Application Protocol) based implementation of the final user with an authentication via a user name and a password can be realized in the same simple way, but is not advantageous because of the low security.

Before starting the real wide band data transfer, the final user will preferably agree via the at least one mobile radiotelephone channel that a wide band data transfer shall take place. In this way the safety of the method according to the invention is increased.

Furthermore, the data to be transferred by means of the wide band data transfer can be preferably selected by the final user via the at least one mobile radiotelephone channel, such that the entire control of the wide band data transfer is under the final user's control.

Furthermore it is advantageous according to the present invention that the wide band data transfer permits to transfer data to several partners, i.e. several wide band terminals are used at the same time. The partners who participate in the wide band data transfer can be advantageously selected by the final user via the at least one mobile radiotelephone channel, such that the final user has the control over the method also in this respect.

The method according to the present invention preferably comprises the following steps:
basic registration of a final user with a provider of the method according to the invention, such that the final user can be unequivocally identified by the provider;
establishment of a wide band connection between a first wide band terminal and a server of the provider, wherein an identification of the final user is carried out;
establishment of a mobile radiotelephone connection between the sever of the provider and a mobile radiotelephone terminal of the identified final user;
final user's confirmation via the mobile radiotelephone connection that a wide band data transfer shall take place and
start of the data transfer in case of a positive confirmation.

In case of a positive confirmation, preferably the server of the provider automatically establishes a wide band connection via a router between the first wide band terminal and another wide band terminal, from which data shall be transferred to the first wide band terminal.

In the following, an embodiment of the method according to the invention will be described in detail with reference to the drawings.

The drawing is a schematic diagram and shows different devices which are used in this embodiment of the method according to the invention, namely a server 10, a router 20, a control server 30, an anonymous wide band terminal 40, mobile terminals 50 of a final user as well as a mobile radiotelephone net 60.

Such data which shall be transferred to a wide band terminal by means of the method according to the invention are memorized on server 10. Before data transfer the data to be sent have to be prepared. The preparation of the data is application specific and can also depend on other parameters, such as the available band width, for example for the transfer of video stream data, or the technical data of the wide band terminal, such as for example resolution or the like. The technologies and methods used for the preparation are assumed to be available and shall not be described in detail here. In case of a plurality of different data, which shall be transferred by means of the method according to the invention, it is advantageous if these data are made available to the final user in a catalogued or prepared way such that the final user can concretely select those data which are to be transferred by using a mobile terminal 50.

The router 20 is the intelligent distributing centre of the method according to the invention. The router 20 is placed between the anonymous wide band terminal 40 and the server 10. It acts as proxiserver and only gives access to the requested data if previously a corresponding session for the anonymous wide band terminal 40 has been authenticated on the control server 30, which will be described in detail hereafter. The router 20 only transfers the data to be transferred from server 10 to the anonymous wide band terminal 40 without processing them further. For this purpose, eventually a safe connection between the anonymous wide band terminal 40 and the server 10 has to be established and again de-established, wherein the router 20 then only routes on the transfer level.

The connection of the router 20 to the other components can be different depending on the respective application. The connection between the router 20 and the server 10 should be safe and of the wide band type. In the most probable case VPN protected internet connections will be used as connection to third servers. VPN stands for “Virtual Private Network”. Thanks to VPN a safe partial net can be built up via an open non protected net, such as for example the internet, in which partial net the communication is protected against monitoring and accesses of extraneous partners. This is achieved by so called “tunnelling” of the data traffic via a VPN server, on which the connections have to be authenticated when being built up, as well as by the simultaneous ciphering of the data. Dedicated lines are also imaginable with highest safety requirements. In case of an implementation with the server 10 this can also be a Local Area Network or briefly LAN or in the simplest case it can be installed on the same computer.

The control server 30 keeps the data communication connection with the final user on the mobile terminal 50. For the session control and the control of the data to be transferred, two different communications with the terminal 50 are provided.

For the session control the control server manages all accesses and sessions during the execution of the method according to the invention. For this, upon each initializing access request the control server 30 generates an unequivocal token that belongs to the session and that is made available to both the anonymous wide band terminal 40 and the mobile terminal 50. The session will pass for authenticated, if the consistency of both tokens is manually confirmed on the mobile terminal 50. If this is the case, the router 20 will be instructed to give access to the desired data for the special anonymous wide band terminal 40 and for the period of the session. The control computer 30 is able to simultaneously manage several sessions via one and the same mobile terminal.

The control server 30 is provided with all session information, such as for example start, end, address of the requesting anonymous wide band terminal, requested data, authentication by the mobile terminal, etc and is therefore able to provide the most important information that is relevant to the invoice.

Apart from controlling the session, the control server 30 is able to receive control statements for the data to be transferred. The control statements can preferably be selected from a menu, such as for example the data which shall be transferred, the order of the data to be transferred or the like. However, control statements concerning the data to be transferred are not treated by the control server 30 itself but eventually transferred via the router 20 to the server 10 and treated there. Since control statements with regard to the data to be transferred are highly application specific, the functioning shall not and cannot be explained in detail here. Generally it is to be noted that a particular logic channel for controlling the data to be transferred is built up via the control server 30 between the mobile terminal 50 and the server 10, by means of which channel a proprietary protocol has to be implemented according to the specifications of the application.

The anonymous wide band terminal 40 can be technically and application specifically designed in a relatively arbitrary way. However, a basic condition is that the anonymous wide band terminal 40 can be unequivocally addressed or identified, such that data can be made available in a defined way. The term “anonymous” means here that the wide band terminal 40 is preset in an only limited way by software or configuration. An anonymous wide band terminal 40 can be for example a public internet access with a web browser, which can be identified and addressed via an IP address. Other application fields might be fax machines, eventually DVB (Digital Video Broadcast) receivers or video streaming servers, which can be identified and be made safely addressable via a mobile terminal 50 by means of the method according to the invention.

For the active control of wide band sessions via a mobile terminal 50, the method according to the invention provides the implementation of application software on the mobile terminal 50. This application software represents the primary user interface for the final user. The application software informs the final user about existing session requests, which are transferred via wide band channels to the control server 30. Such requests can be rejected or accepted by means of the mobile terminal. Herein, each request is identified by a token, which has been generated by the control server 30. After comparison of the token with the anonymous wide band terminal 40 the final user can confirm or refuse the session on the mobile terminal 50. Several session requests can be treated individually and in parallel by means of the mobile terminal 50. Thereby it is for example possible to realise a web casting for closed user groups in an easy way. Via the mobile radiotelephone net the mobile terminal 50 maintains a packet switched data connection to the control server 30, such as for example GPRS, UMTS or the like. It is important that this connection is safely authenticated. For this, several methods are imaginable. The simplest possibility is to make use of the authentication of the mobile phone which has already been realized in the net of the mobile radiotelephone operator. In addition to the IP address, which is temporally but unequivocally allocated to the mobile phone and thus to the final user, the mobile radiotelephone operator can safely determine the identity in form of an allocation to the MSISDN of the final user. Other methods are also imaginable and can be implemented. For example, the access to the SIM card from the application software is possible by means of API and can be used for the identification. Within the scope of a special provisioning process, safe keys for a PKI method can also be saved on the mobile terminal and be used for the authentication of the final user. A simple WAP based implementation of the mobile terminal 50 with an authentication with respect to the control server 30 by means of a user name and a password can also be realized in the same simple way, but is not advantageous because of the low security.

In the following an application example of the above described embodiment of the method according to the invention will be described, in which a final user likes to fetch e-mail appendices that are on his private server 10 from a publicly accessible wide band terminal 40. The final user is basically registered with the provider of the method according to the invention, with whom the control server 30 is also positioned, and can be unequivocally identified by this one. A personal internet page is made available to him, which is for example allocated to the SIM card of his mobile phone.

For fetching his e-mail appendices the final user goes to a publicly accessible anonymous wide band terminal 40 and opens his personal internet page via this one. By opening the internet page, a session request is generated and transferred to the control server 30. This one generates an unequivocal token for the requested session. Herein, the control server 30 assures that this token has not yet been used for another parallel session of the same final user. The token for example consists of a combination of the IP address of the requesting anonymous wide band terminal 40 and a time stamp, but could also be a much simpler arbitrary sign. Thereupon, the control server 30 generates a small html page and sends this one back to the anonymous wide band terminal 40. This html page makes the token visible for the final user on the anonymous wide band terminal 40. The html page additionally contains a mechanism, by means of which the page, which is shown on the anonymous wide band terminal 40, can be modified or actualised by the control server 30. This can for example be a small JavaScript, which queries every second about changes of the contents, a so called polling.

Furthermore, the control server 30 transfers the session request together with the associated token via a mobile data channel of a mobile radiotelephone net 60 to the mobile phone 50 of the final user. Thereupon, the final user can compare the token shown on the mobile phone 50 with the token shown on the anonymous wide band terminal 40. If the tokens match, the final user accepts the session by acknowledging the session request via the mobile phone 50. This acknowledgement is again transferred via a mobile data channel of the mobile radiotelephone net 60 to the control server 30. The session is now identified in the control server 30. Accordingly, the control server 30 diverts the request introduced via the mobile phone 50 to the personal server 10 of the final user by means of the router 20. Between the personal server 10 and the router 20 a safe connection is established, which is for example protected by a VPN tunnel via a wide band internet access. The protocol between the mobile phone 50 and the personal server 10 is secured, for example by https, such that neither the control server 30 nor the router 20 can get to know the transferred contents.

The selection and control of the data to be transferred from the personal server 10 to the publicly accessible anonymous wide band terminal 40 can be realized both via the mobile phone 50 and interactively via the anonymous wide band terminal 40. For different reasons a suitable mix of both has to be eventually preferred. In the following it is assumed that in the present example the control is only realised via the mobile phone 50.

The mobile phone 50 is in permanent connection with the personal server 10 via a mobile radiotelephone channel. This connection is passed via the control server 30, the router 20 and from there via the VPN tunnel to the personal server 10. The personal server 10 provides, via this connection, a selection of the received e-mails with the associated appendices. Herein, for example only the file names of the appendices, but not the appendices themselves are transferred. In this way the connection via the mobile radiotelephone channel will not be over-loaded by too high transfer loads. The method neither requires any memory capacity for memorizing the appendices on the mobile phone. The final user selects an appendix by means of the mobile phone 50, which appendix shall be displayed on the anonymous wide band terminal 40. This selection is again transferred via the mobile radiotelephone channel to the personal server 10. The appendix shown in the html format is made available to the anonymous wide band terminal 40 and displayed there in large format. Herein, the data containing the e-mail appendix are exclusively transferred via the available wide band data channels. After having viewed the appendices the final user can optionally select other data by means of his mobile phone 50 and transfer the corresponding selection via the mobile radiotelephone channel to the personal server 10. The personal server 10 makes then the html version of the selected file available to the anonymous wide band terminal 40 via a wide band channel for inspection.

Such a session will be closed via the mobile phone 50. If the connection via the mobile radiotelephone channel is interrupted by the final user, the control server 30 will be informed and will deactivate the session. The personal server 10 also receives a corresponding message, whereupon no more data will be released for viewing. The https connection between router 20 and personal server 10 is de-established, such that the router 20 will not transfer any further requests from the anonymous wide band terminal 40 to the personal server 10. The control server 30 writes the session data in a log file and memorizes them.

It is to be understood that both the above described exemplary embodiment and the application example are not limiting. On the contrary, other applications can be realised:

For example also streaming servers can be selected by the final user via a mobile terminal 50, whereby a so called video-on-demand process can be realized. Video or music streams can be correspondingly made available in an anonymous way by means of the method according to the invention. Herein, the log-in functions of the control server 30 permit an easy invoicing of the session.

Furthermore, for critical applications in companies with web interfaces, safe internet accesses can be realized by means of the method according to the invention. An increased safety is given for the IT organisation in that an authentication is realized by means of the mobile terminal. The clearing of the internet access is also realized via the mobile terminal and is only temporary, i.e. limited for the period of the session. This also increases the access safety.

Furthermore, the incorporation of DVB-T or DVB-H for triggering television receivers via a mobile terminal and for showing personal data is imaginable.

1. A method for transferring a wide band data transfer to an anonymous wide band terminal, comprising:
transferring the wide band data transfer by via at least one wide band channel; and
carrying out a control statement for the wide band data transfer via at least one mobile radiotelephone channel of a mobile radiotelephone network.

2. The method of claim 1 wherein at least one mobile radiotelephone terminal is used for carrying out the control statement.

3. The method of claim 1 further comprising identifying at least one of a final user, a basic registration of the final user, and an identification of the final user.

4. The method of claim 3 wherein the at least one mobile radiotelephone channel identifies at least one of the final user, the basic registration of the final user, and the identification of the final user before starting the wide band data transfer.

5. The method of claim 3 wherein the final user agrees via the at least one mobile radiotelephone channel to realize wide band data transfer before starting the wide band data transfer.

6. The method of claim 3 wherein the final user selects data of the wide band data transfer via the at least one mobile radiotelephone channel.

7. The method of claim 1 wherein the wide band data transfer transfers data to a plurality of partners.

8. The method of claim 7 further comprising using a final user to select the plurality of the partners via the at least one mobile radiotelephone channel.

9. The method of claim 3 further comprising:
registering the final user with a provider that identifies the final user;
establishing a wide band connection between a first wide band terminal and a server of the provider that carries out the identification of the final user;
establishing a mobile radiotelephone connection between the server of the provider and a mobile radiotelephone terminal of the identified final user;
transferring the wide band data transfer via the mobile radiotelephone connection based on a confirmation of the final user; and
starting the data transfer based on the confirmation of the final user.

10. The method of claim 9, further comprising generating a second wide band connection between the first wide band terminal and another wide band terminal that transfers data to the first wide band terminal.

11. A system for performing a wide band data transfer to an anonymous wide band terminal, comprising:
at least one wide band channel that transfers the wide band data transfer; and
at least one mobile radiotelephone channel of a mobile radiotelephone net that transfers a control statement for the wide band data transfer.

12. The system of claim 11 further comprising a personal server that stores data of the wide band data transfer.

13. The system of claim 12 further comprising:
a mobile radiophone terminal that carries out the control statement for the wide band data transfer; and
a control server that maintains a connection between the mobile radiophone terminal and the control server, that generates a plurality of authentication tokens of the wide band data transfer, that manages the wide band data transfer to the anonymous wide band terminal.

14. The system of claim 13 wherein the control server provides at least one of the plurality of authentication tokens to the anonymous wide band terminal and the mobile radiophone terminal.

15. The system of claim 14 further comprising a router that transfers the data of the wide band data transfer when the mobile radiophone terminal confirms a consistency among the at least one of the plurality of authentication tokens.

16. The system of claim 15 wherein the control server stores information of the wide band data transfer including at least one of a start of the wide band data transfer, an end of the wide band data transfer, an address of the anonymous wide band terminal, and the consistency.

17. The system of claim 13 wherein the mobile radiotelephone terminal selects and controls the data of the wide band data transfer transferred from the persona server.

18. The system of claim 13 further comprising a final user that at least one of accepts and rejects the wide band data transfer via the mobile radiotelephone terminal.

19. The system of claim 18 wherein the mobile radiotelephone terminal selectively ends the wide band data transfer.
